(19) United States
(12) Patent Application Publication
(10) Pub. No.: US 2021/0376639 A1
(43) Pub. Date: Dec. 2, 2021

(54) SYSTEM FOR OUTPUT RATIO CONFIGURATION OF START-UP BATTERY AND RAPID ENERGY STORAGE MODULE IN PARALLEL

(71) Applicant: TEAM YOUNG TECHNOLOGY CO., LTD., Taoyuan City (TW)

(72) Inventor: Tz-Min Lin, Taoyuan City (TW)

(73) Assignee: TEAM YOUNG TECHNOLOGY CO., LTD., Taoyuan City (TW)

(21) Appl. No.: 17/190,426

(22) Filed: Mar. 3, 2021

(30) Foreign Application Priority Data
May 29, 2020 (CN) 202010474535.8

(51) Int. Cl. H02J 7/00; H02P 1/02

(52) U.S. Cl. CPC H02J 7/0063; H02P 1/02; H02J 7/0013

(57) ABSTRACT

The disclosure provides a system for output ratio configuration of start-up battery and rapid energy storage module starts a start-up motor in a start-up mode, including a start-up battery having a voltage and a higher voltage rapid energy storage module having a voltage. The higher voltage rapid energy storage module connects the start-up battery in parallel. In the start-up mode, the voltage of the higher voltage rapid energy storage module for connecting the start-up battery in parallel is greater than the voltage of the start-up battery, which is used to set an electrical output ratio of the start-up battery and the higher voltage rapid energy storage module respectively to provide for a load current of the start-up motor. The sum of the electrical output ratio of the start-up battery plus the electrical output ratio of the higher voltage rapid energy storage module is equal to 1.

### CROSS-REFERENCE TO RELATED APPLICATION

This application claims the priority benefit of China application serial no. 202010474535.8, filed on May 29, 2020. The entirety of the above-mentioned patent application is hereby incorporated by reference herein and made a part of this specification.

### BACKGROUND

### 1. Technical Field

The disclosure relates to the lifetime of a start-up battery, and particularly relates to a system for output ratio configuration of start-up battery and rapid energy storage module.

### 2. Description of Related Art

Currently, for devices that use start-up batteries (e.g. lead-acid batteries) to start engines, high currents loaded instantaneously is needed. Repeated operation will lead to deterioration of the start-up batteries, resulting in higher internal resistance value, and the start-up batteries deteriorate even faster with the constant high current of the start-up engine constantly loaded, which causes the start-up batteries to fail gradually. The lifetime of start-up batteries such as lead-acid batteries or others will be affected by different loaded currents.

The current technology to extend the lifetime of the start-up batteries is to directly connect the supercapacitor set to the start-up battery in parallel to reduce the start-up battery output so as to effectively extend the lifetime of the start-up batteries. There are two disadvantages of this method. First, when the power of the start-up battery drops, the voltage of the start-up battery will also drop, so the voltage of the supercapacitor set connected in parallel will drop as well, which still cannot solve the problem that vehicles or the other cannot start due to insufficient start-up battery voltage. Second, the internal resistance value of the existing supercapacitor set is still relatively large, so the output of the supercapacitor set after being parallel connected is hardly greater than that of the start-up battery. In other words, the magnitude of reduction in the output of the start-up battery is very small, probably less than 20%, and has a limited effect. Therefore, it is urgent to solve the problem of how to use the supercapacitor set more effectively to enhance the lifetime of the start-up battery.

### SUMMARY

In view of the above-mentioned, the disclosure is based on the fact that the lifetime of the start-up battery, namely the period of use time from the first use of the start-up battery to the time when the load current of the start-up motor cannot be drawn after charging, will be affected by different loaded currents. Therefore, according to the disclosure, in a start-up mode, by connecting a higher voltage rapid energy storage module (for example, a supercapacitor set) to a start-up battery (for example, a lead-acid battery) in parallel, the higher voltage rapid energy storage module connected in parallel to the start-up battery can provide the start-up motor an electrical output ratio having a higher load current, such that more electric power to start the start-up motor can be jointly provided, thereby further reducing a loaded current of the start-up battery so as to extend the lifetime of the start-up battery. The higher voltage rapid energy storage module may be configured as a short time high-current discharge device. Therefore, when a high-current discharge device (such as a generator or an automobile or a locomotive) is required, it is quite suitable to use a higher voltage rapid energy storage module to provide high current jointly.

In order to achieve the above objective, the main objective of the disclosure is to provide a system for output ratio configuration of start-up battery and rapid energy storage module, starting a start-up motor in a start-up mode and including a start-up battery having a voltage; and a higher voltage rapid energy storage module having a voltage, the higher voltage rapid energy storage module connected in parallel to the start-up battery; where in the start-up mode, the voltage of the higher voltage rapid energy storage module for connecting the start-up battery in parallel is greater than the voltage of the start-up battery, which is used to set an electrical output ratio of the start-up battery and the higher voltage rapid energy storage module respectively to provide for a load current of the start-up motor, wherein a sum of the electrical output ratio of the start-up battery plus the electrical output ratio of the higher voltage rapid energy storage module is equal to 1, so as to extend a lifetime of the start-up battery.

Moreover, in order to achieve the above objective, in the system for output ratio configuration of start-up battery and rapid energy storage module in parallel of the disclosure, the following formulas are satisfied: Rᵣ₁₀=I_{TH}/(I_{TH}+I_{C}), and Rᵣ₂₀=I_{C}/(I_{TH}+I_{C}), where I_{TH}=(V_{TH}−R_{L}×(I_{TH}+I_{C}))/R_{TH}, and I_{C}=(V_{C}−R_{L}×(I_{TH}+I_{C}))/R_{C}, where V_{TH} is the voltage of the start-up battery; V_{C} is the voltage of the higher voltage rapid energy storage module; Rᵣ₁₀ is the electrical output ratio of the start-up battery connected in parallel to the higher voltage rapid energy storage module; Rᵣ₂₀ is the electrical output ratio of the higher voltage rapid energy storage module connected in parallel to the start-up battery; R_{TH} is an internal resistance value of the start-up battery; I_{TH} is a loaded current of the start-up battery; I_{C} is a loaded current of the higher voltage rapid energy storage module; R_{C} is an internal resistance value of the higher voltage rapid energy storage module; and R_{L} is a load impedance value of the start-up motor.

In addition, in order to achieve the above objective, the system for output ratio configuration of start-up battery and rapid energy storage module of the disclosure, a range of the electrical output ratio of the start-up battery is between 20% and 80%; or a range of the electrical output ratio of the start-up battery is between 30% and 70%; or a range of the electrical output ratio of the start-up battery is between 40% and 60% and a range of the electrical output ratio of the higher voltage rapid energy storage module is between 20% and 80%; or the range of the electrical output ratio of the higher voltage rapid energy storage module is between 30% and 70%, or the range of the higher voltage rapid energy storage module is between 40% and 60%, wherein the sum of the electrical output ratio of the start-up battery plus the electrical output ratio of the higher voltage rapid energy storage module is equal to 1.

Moreover, in order to achieve the above objective, in the system for output ratio configuration of start-up battery and rapid energy storage module in parallel of the disclosure, the electrical output ratio Rᵣ₁₀ of the start-up battery is set to 80%, the electrical output ratio Rᵣ₂₀ of the higher voltage rapid energy storage module is set to 20%, and the start-up battery increases a lifetime by more than 3 times; or the electrical output ratio Rᵣ₁₀ of the start-up battery is set to 70%, the electrical output ratio Rᵣ₂₀ of the higher voltage rapid energy storage module is set to 30%, and the start-up battery can increase the lifetime by more than 5 times; or the electrical output ratio Rᵣ₁₀ of the start-up battery is set to 60%, the electrical output ratio Rᵣ₂₀ of the higher voltage rapid energy storage module is set to 40%, and the start-up battery can increase the lifetime by more than 9 times; or the electrical output ratio Rᵣ₁₀ of the start-up battery is set to 50%, the electrical output ratio Rᵣ₂₀ of the higher voltage rapid energy storage module is set to 50%, and the start-up battery can increase the lifetime by more than 16 times; or the electrical output ratio Rᵣ₁₀ of the start-up battery is set to 40%, the electrical output ratio Rᵣ₂₀ of the higher voltage rapid energy storage module is set to 60%, and the start-up battery can increase the lifetime by more than 31 times; or the electrical output ratio Rᵣ₁₀ of the start-up battery is set to 30%, the electrical output ratio Rᵣ₂₀ of the higher voltage rapid energy storage module is set to 70%, and the start-up battery can increase the lifetime by more than 74 times; or the electrical output ratio Rᵣ₁₀ of the start-up battery is set to 20%, the electrical output ratio Rᵣ₂₀ of the higher voltage rapid energy storage module is set to 80%, and the start-up battery can increase the lifetime by more than 250 times.

Moreover, in order to achieve the above objective, in the system for output ratio configuration of start-up battery and rapid energy storage module in parallel of the disclosure, the start-up motor is used to restart a vehicle engine having an idling stop system, in which a number of starts is N times compared with a conventional start-up motor where N is an arithmetical average or a rounded positive integer, where the range of the electrical output ratio of the start-up battery is between 20% and 50%; or the range of the electrical output ratio of the start-up battery is between 30% and 40% and the range of the electrical output ratio of the higher voltage rapid energy storage module is between 50% and 80%; or the range of the electrical output ratio of the higher voltage rapid energy storage module is between 60% and 70%, wherein the sum of the electrical output ratio of the start-up battery plus the higher voltage rapid energy storage module is equal to 1.

Moreover, in order to achieve the above objective, in the system for output ratio configuration of start-up battery and rapid energy storage module in parallel of the disclosure, the start-up motor is used to restart a vehicle engine having an idling stop system, in which a number of starts is N times compared with a conventional start-up motor where N is an arithmetical average or a rounded positive integer, where the electrical output ratio Rᵣ₁₀ of the start-up battery is set to 50%, the electrical output ratio Rᵣ₂₀ of the higher voltage rapid energy storage module is set to 50%, and the start-up battery increases a lifetime by 16 times divided by N or more; or the electrical output ratio Rᵣ₁₀ of the start-up battery is set to 40%, the electrical output ratio Rᵣ₂₀ of the higher voltage rapid energy storage module is set to 60%, and the start-up battery increases a lifetime by 31 times divided by N or more; or the electrical output ratio Rᵣ₁₀ of the start-up battery is set to 30%, the electrical output ratio Rᵣ₂₀ of the higher voltage rapid energy storage module is set to 70%, and the start-up battery increases a lifetime by 74 times divided by N or more; or the electrical output ratio Rᵣ₁₀ of the start-up battery is set to 20%, the electrical output ratio Rᵣ₂₀ of the higher voltage rapid energy storage module is set to 80%, and the start-up battery increases a lifetime by 250 times divided by N or more.

Moreover, in order to achieve the above objective, in the system for output ratio configuration of start-up battery and rapid energy storage module in parallel of the disclosure, where the start-up motor, after connecting to the start-up battery and started, immediately enters the start-up mode after a time point at which the voltage of the start-up battery drops instantaneously to produce a predetermined voltage difference, where the predetermined voltage difference is the voltage of the start-up battery when the start-up motor stops, minus the voltage of the start-up battery when a loaded current of the start-up battery flows through an internal resistance value of the start-up battery.

Moreover, in order to achieve the above objective, in the system for output ratio configuration of start-up battery and rapid energy storage module in parallel of the disclosure, a charging mode is further included, where in the charging mode, the higher voltage rapid energy storage module is disconnected from the parallel connection with the start-up battery, and the start-up battery is boosted so as to charge the higher voltage rapid energy storage module until a predetermined condition is met, where the predetermined condition is that a range of the voltage of the higher voltage rapid energy storage module for connecting the start-up battery in parallel is between greater than the voltage of the start-up battery and less than or equal to a rated voltage of the higher voltage rapid energy storage module.

The detailed structure, characteristics, assembly or use of the output ratio configuration system of start-up battery and fast energy storage module in parallel provided by the disclosure will be described in the detailed description of the subsequent embodiments. However, those with ordinary knowledge in the art should be able to understand that these detailed descriptions and specific embodiments for implementing the disclosure are only used to illustrate the disclosure, and are not intended to limit the scope of the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to illustrate the principles of the disclosure.

FIG. 1 is a block diagram of a system for output ratio configuration of start-up battery and rapid energy storage module in parallel according to an embodiment of the disclosure.

FIG. 2 is an equivalent circuit diagram of a start-up motor, a higher voltage rapid energy storage module, and a start-up battery according to an embodiment of the disclosure.

### DESCRIPTION OF THE EMBODIMENTS

Hereinafter, the corresponding exemplary embodiments are given in conjunction with the drawings to illustrate the components, actions and effects of the system for output ratio configuration of start-up battery and rapid energy storage module in parallel of the disclosure. However, the components, sizes and appearances of a system 10 for output ratio configuration of start-up battery and rapid energy storage module in parallel in the drawings are only configured to illustrate the technical features of the disclosure, but not to limit the disclosure.

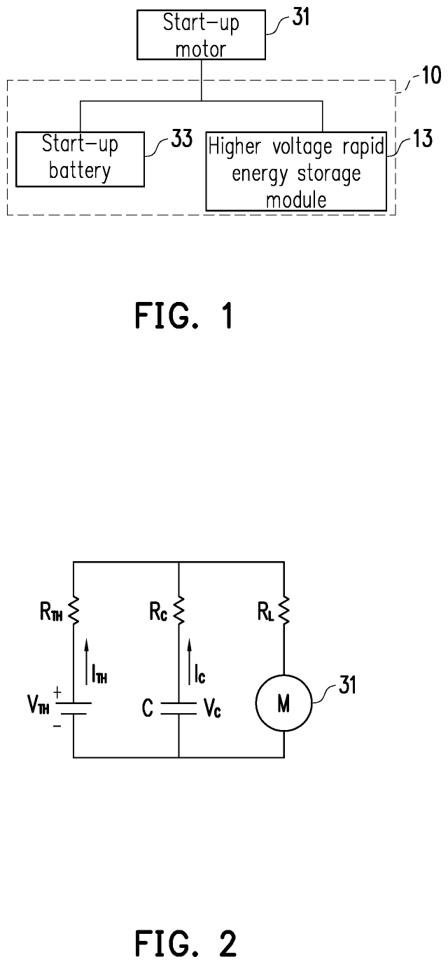

Referring to an embodiment shown in FIG. 1, a system 10 for output ratio configuration of start-up battery and rapid energy storage module in parallel of the disclosure include a start-up battery 33 and a higher voltage rapid energy storage module 13. In the present embodiment, the higher voltage rapid energy storage module 13 may be connected in parallel to the start-up battery 33 in a start-up mode through a switch (not shown). Generally speaking, before the start-up mode, only a start-up motor 31 is connected to the start-up battery 33, so it is necessary to wait for the load of the start-up motor 31 to be started before starting the parallel process by connecting the higher voltage rapid energy storage module 13 to the start-up battery 33 in parallel; otherwise the higher voltage rapid energy storage module 13 will be directly equipotential with the start-up battery 33. Therefore, when it is detected the start-up motor 31 is started by a user, it enters the start-up mode, and the start-up battery 33 and the higher voltage rapid energy storage module 13 are then electrically connected in parallel. The voltage of the higher voltage rapid energy storage module 13 for connecting the start-up battery 33 in parallel is greater than the voltage of the start-up battery 33, such that the higher voltage rapid energy storage module 13 and the start-up battery 33 can jointly provide the power required by the start-up motor 31 to start, and then drive the engine. The higher voltage rapid energy storage module 13 is configured as a power supply aid for the start-up battery 33.

According to an embodiment of the disclosure, whether the start-up motor 31 enters the start-up mode may be judged by measuring a voltage of the start-up battery 33 connected to the start-up motor 31. The start-up motor 31 needs an instantaneous large current to drive during starting, but at this time only the start-up motor 31 is connected to the start-up battery 33 and only an instantaneous loaded current I_{TH} flows out from the start-up battery 33. Therefore, the voltage of the start-up battery 33 will show a large drop in the waveform at the instant when the start-up motor 31 begins to start, and the start-up motor 31 immediately enters the start-up mode after a predetermined voltage difference occurs. The predetermined voltage difference is the voltage of the start-up battery 33 when the start-up motor 31 stops, minus the voltage of the start-up battery 33 when a loaded current of the start-up battery 33 flows through an internal resistance value of the start-up battery 33.

The system 10 for output ratio configuration of start-up battery and rapid energy storage module in parallel of the disclosure further includes a switch (not shown) and a processing circuit (not shown). The switch is configured to control the connection between the start-up battery 33 and the higher voltage rapid energy storage module 13. In the start-up mode, a processing circuit controls the switch to connect the higher voltage rapid energy storage module 13 to the start-up battery 33 in parallel. When the processing circuit is in a charging mode, it controls the switch to disconnect the higher voltage rapid energy storage module 13 from the parallel connection with the start-up battery 33. The processing circuit includes a buck-boost module (not shown) configured to boost the low-voltage start-up battery 33 and charge the higher voltage rapid energy storage module 13 until a predetermined condition is met. The predetermined condition is that a range of the voltage of the higher voltage rapid energy storage module 13 for connecting the start-up battery 33 in parallel is between greater than the voltage of the start-up battery 33 and less than or equal to a rated voltage of the higher voltage rapid energy storage module 13, such that the higher voltage rapid energy storage module 13 can be connected in parallel at any time in the start-up mode to assist the start-up battery 33 to supply the load of the start-up motor 31. However, the charging mode of the disclosure is not limited thereto.

In an embodiment of the disclosure, for example, the higher voltage rapid energy storage module 13 is a supercapacitor set; the charging and discharging speed of the higher voltage rapid energy storage module 13 is faster than that of the start-up battery 33, and the lifetime of the higher voltage rapid energy storage module 13 is longer than that of the star-up battery 33. Therefore, the voltage of the higher voltage rapid energy storage module 13 can be charged in a short time, such that the range of voltage of the higher voltage rapid energy storage module 13 for connecting the start-up battery 33 in parallel is between greater than the voltage of the start-up battery 33 and less than or equal to the rated voltage of the higher voltage rapid energy storage module 13. However, the higher voltage rapid energy storage module 13 is not limited to a supercapacitor set.

The composition of the system 10 for output ratio configuration of start-up battery and rapid energy storage module in parallel of the disclosure is described above. The operation and effect of the system 10 for output ratio configuration of start-up battery and rapid energy storage module in parallel of the disclosure are described in detail in the following.

Please refer to an embodiment shown in FIG. 1 and FIG. 2. In the present embodiment of the disclosure, a generator or an automobile or a locomotive in the start-up mode, the higher voltage rapid energy storage module 13 is electrically connected in parallel to the start-up battery 33 to jointly provide the load current of the start-up motor 31. The voltage V_{C} of the higher voltage rapid energy storage module 13 for connecting the start-up battery 33 in parallel is greater than the voltage V_{TH} of the start-up battery 33; the equivalent circuit diagram is shown in FIG. 2. V_{TH} is the voltage of the start-up battery 33; I_{TH} is the loaded current of the start-up battery 33; R_{TH} is the internal resistance value of the start-up battery 33; C is a capacitance value of the higher voltage rapid energy storage module 13; V_{C} is the voltage of the higher voltage rapid energy storage module 13; I_{C} is a loaded current of the higher voltage rapid energy storage module; R_{C} is an internal resistance value of the higher voltage rapid energy storage module 13; and R_{L} is a load impedance value of the start-up motor 31.

Please continue to refer to an embodiment shown in both FIG. 1 and FIG. 2. In this embodiment of the disclosure, when a generator or an automobile or a locomotive is in the start-up mode, the higher voltage rapid energy storage module 13 is connected in parallel to the start-up battery 33, such that the voltage of the higher voltage rapid energy storage module 13 connected in parallel to the start-up battery 33 is greater than the voltage of the start-up battery 33, so as to adjust an electrical output ratio of the start-up battery 33 and the higher voltage rapid energy storage module 13 in such a way that the electric power to start the start-up motor 31 is shared jointly, thereby extending the lifetime of the start-up battery 33. For example, in the start-up mode, the range of the voltage V_{C} of the higher voltage rapid energy storage module 13 connected in parallel to the start-up battery 33 is between greater than the voltage V_{TH} of the start-up battery 33 and less than or equal to a rated voltage of the higher voltage rapid energy storage module 13, which is used to set an electrical output ratio of the start-up battery 33 and the higher voltage rapid energy storage module 13 respectively to provide for the load current I_{L} of the start-up motor 31. In other words, the electrical output ratio of the start-up battery 33 is the ratio of the loaded current I_{TH} of the start-up battery 33 to the load current I_{L} of the start-up motor 31, and the electrical output ratio of higher voltage rapid energy storage module 13 is the ratio of the loaded current I_{C} of the higher voltage rapid energy storage module 13 to the load current I_{L} of the start-up motor 31. The sum of the electrical output ratio of the start-up battery 33 plus the electrical output ratio of the higher voltage rapid energy storage module 13 is equal to 1; that is, the electrical output ratio of the higher voltage rapid energy storage module 13 is increased and the electrical output ratio of the start-up battery 33 is reduced, so as to achieve the purpose of extending the lifetime of the start-up battery.

Please continue to refer to FIG. 2. In one embodiment, taking the start-up battery 33 and the higher voltage rapid energy storage module 13 of an vehicle as an example, the higher voltage rapid energy storage module 13 is a supercapacitor set, and the start-up battery 33 is a lead-acid battery, where the lead-acid battery has an internal resistance value and the supercapacitor set has an internal resistance value. In the start-up mode, the voltage of the higher voltage rapid energy storage module 13 for connecting the start-up battery 33 in parallel is between greater than the voltage of the start-up battery 33 and less than or equal to a rated voltage of the higher voltage rapid energy storage module 13, which is used to set an electrical output ratio of the start-up battery 33 and the higher voltage rapid energy storage module 13 respectively to provide for the load current of the start-up motor 31, in which the following formulas are satisfied: formula (1): Rᵣ₁₀=I_{TH}/(I_{TH}+I_{C}); formula (2): Rᵣ₂₀=I_{C}/(I_{TH}+I_{C}); formula (3): I_{TH}=(V_{TH}−R_{L}× (I_{TH}+I_{C}))/R_{TH}; and formula (4): I_{C}=(V_{C}−R_{L}× (I_{TH}+I_{C}))/R_{C}, where V_{TH} is the voltage of the start-up battery 33; V_{C} is the voltage of the higher voltage rapid energy storage module 13; Rᵣ₁₀ is the electrical output ratio of the start-up battery 33 connected in parallel to the higher voltage rapid energy storage module 13; Rᵣ₂₀ is the electrical output ratio of the higher voltage rapid energy storage module 13 connected in parallel to the start-up battery 33; R_{TH} is the internal resistance value of the start-up battery 33; I_{TH} is a loaded current of the start-up battery 33; I_{C} is a loaded current of the higher voltage rapid energy storage module 13; the load current I_{L} of the start-up motor 31 is I_{TH}+I_{C}; R_{C} is the internal resistance value of the higher voltage rapid energy storage module 13; and R_{L} is a load impedance value of the start-up motor 31. From formula (4), it can be known that by increasing the voltage V_{C} of the higher voltage rapid energy storage module 13, the loaded current I_{C} of the higher voltage rapid energy storage module 13 can be effectively increased; then from the formula (3), the loaded current I_{TH} of the start-up battery 33 is reduced so as to achieve the purpose of reducing the output power of the start-up battery 33, thus effectively extending the lifetime of the start-up battery 33.

The embodiment of the disclosure is based on the fact that the lifetime of lead-acid batteries will be affected by different loaded currents. Therefore, by providing a supercapacitor set, in the start-up mode, the higher voltage supercapacitor set is connected in parallel to the lead-acid battery, such that the voltage of the higher voltage supercapacitor set connected in parallel to the lead-acid battery is greater than the voltage of the lead-acid battery, and the electric power is jointly provided to the start-up engine (for example, the start-up motor 31) so as to reduce the loaded current of the lead-acid battery, thereby extending the lifetime of the lead-acid battery. For example, by setting the electrical output ratio of lead-acid battery at about 50% and setting the electrical output ratio of the higher voltage supercapacitor set at about 50%, half of the loaded current of the lead-acid battery can be reduced; compared with the same lead-acid battery, the number of use times can be increased by more than 2 times. This is the first benefit. Further, the lead-acid battery deteriorates with the increase in the number of use times; by reducing half of the loaded current lead-acid battery, the deterioration of the lead-acid battery is slowed by half, and the lifetime of the lead-acid battery can be further increased by more than 2 times. This is the second benefit. As the number of use times increase, the lead-acid battery deteriorates and causes the internal resistance value of the lead-acid battery to gradually increase, but the internal resistance value of supercapacitor set is almost unchanged, so the electrical output ratio of the lead-acid battery is reduced until it is zero. In this way, the deterioration of the lead-acid battery electrolyte can be greatly slowed down, the deterioration of the lead-acid battery can be further reduced by half, and the lifetime of the lead-acid battery can be further increased by more than 2 times. This is the third benefit. Moreover, for the electricity that a supercapacitor set requires to start the start-up motor 31 alone, the start-up motor 31 can be started as long as 1% of the capacity of the start-up battery 33 remains (depending on the battery capacity), and as long as the supercapacitor set can be fully charged. In contrast to a conventional lead-acid originally designed such that the lead-acid battery cannot draw the target current (such as cold start-up current CCA) when deteriorated to 50%, the start-up battery 33 now can be used until a lower limit of an actual minimum remaining power sufficient to charge the supercapacitor set until there is enough voltage for starting. Therefore, all available electric energy of the lead-acid battery can be exhausted, and the purpose of extending the lifetime of the lead-acid battery can be achieved. Thus, the use time of the lead-acid battery is expected to increase 2 times. This is the fourth benefit. In this way, while the average lifetime of the lead-acid battery was originally two years, when the above four multiplying benefits are combined, the lifetime of lead-acid batteries can be increased to more than 16 times (more than 32 years). Since the service lifetime of ordinary vehicles is about 20 years, it is not necessary to replace the lead-acid battery before the vehicle is scrapped.

For another example, by setting the electrical output ratio Rᵣ₁₀ of the start-up battery 33 to 80% and setting the electrical output ratio Rᵣ₂₀ of the higher voltage rapid energy storage module 13 to 20%, the above four multiplying benefits (100%/80%)×(100%/80%)×(100%/80%)×2 are combined, and the lifetime of the start-up battery 33 is increased by more than 3 times; or by setting the electrical output ratio Rᵣ₁₀ of the start-up battery 33 to 70% and setting the electrical output ratio Rᵣ₂₀ of the higher voltage rapid energy storage module 13 to 30%, the above four multiplying benefits (100%/70%)×(100%/70%)×(100%/70%)×2 are combined, and the lifetime of the start-up battery 33 is increased by more than 5 times; or by setting the electrical output ratio Rᵣ₁₀ of the start-up battery 33 to 60% and setting the electrical output ratio Rᵣ₂₀ of the higher voltage rapid energy storage module 13 to 40%, the above four multiplying benefits (100%/60%)×(100%/60%)×(100%/60%)×2 are combined, and the lifetime of the start-up battery 33 is increased by more than 9 times; or by setting the electrical output ratio Rᵣ₁₀ of the start-up battery 33 to 40% and setting the electrical output ratio Rᵣ₂₀ of the higher voltage rapid energy storage module 13 to 60%, the above four multiplying benefits (100%/40%)×(100%/40%)×(100%/40%)×2 are combined, and the lifetime of the start-up battery 33 is increased by more than 31 times; or by setting the electrical output ratio Rᵣ₁₀ of the start-up battery 33 to 30% and setting the electrical output ratio Rᵣ₂₀ of the higher voltage rapid energy storage module 13 to 70%, the above four multiplying benefits (100%/30%)×(100%/30%)×(100%/30%)×2 are combined, and the lifetime of the start-up battery 33 is increased by more than 74 times; or by setting the electrical output ratio Rᵣ₁₀ of the start-up battery 33 to 20% and setting the electrical output ratio Rᵣ₂₀ of the higher voltage rapid energy storage module 13 to 80%, the above four multiplying benefits (100%/20%)×(100%/20%)×(100%/20%)×2 are combined, and the lifetime of the start-up battery 33 is increased by more than 250 times. Thus, the range of the electrical output ratio of the start-up battery 33 is between 20% and 80%; or the range of the electrical output ratio of the start-up battery 33 is between 30% and 70%; or the range of the electrical output ratio of the start-up battery 33 is between 40% and 60% and the range of the higher voltage rapid energy storage module 13 is between 20% and 80%; or the range of the electrical output ratio of the higher voltage rapid energy storage module 13 is between 30% and 70%; or the range of the higher voltage rapid energy storage module 13 is between 40% and 60%. The sum of the electrical output ratio of the start-up battery 33 plus the electrical output ratio of the higher voltage rapid energy storage module 13 is equal to 1. In this way, the deterioration of the start-up battery 33 is greatly reduced, and the purpose of extending the service lifetime of the start-up battery can be achieved.

For another example, when a vehicle has an idling stop system, the number of starts is N times that of ordinary vehicles; therefore, in order to reduce pollution and fuel consumption, some vehicle manufacturers install start/stop systems in new generation models. In such case, when the vehicle is stopped, the engine is turned off, and when the driver's foot moves from the brake pedal to the accelerator pedal, the engine is automatically restarted, which helps to reduce fuel consumption during busy periods of urban driving and stop-and-go traffic while reducing air pollution. In the disclosure, the start-up battery 33 (such as a lead-acid battery) and the higher voltage rapid energy storage module 13 (such as a supercapacitor set) are used to supply power when the vehicle is equipped with an idling stop system (start/stop system), in which the number of starts is N times compared with the conventional start-up motor where N is an arithmetical average or a rounded positive integer. By setting the electrical output ratio Rᵣ₁₀ of the start-up battery 33 to 50% and setting the electrical output ratio Rᵣ₂₀ of the higher voltage rapid energy storage module 13 to 50%, the above four multiplying benefits (100%/50%)×(100%/50%)×(100%/50%)×2 divided by N are combined, and the lifetime of the start-up battery 33 is increased by more than 16 times divided by N; or by setting the electrical output ratio Rᵣ₁₀ of the start-up battery 33 to 40% and setting the electrical output ratio Rᵣ₂₀ of the higher voltage rapid energy storage module 13 to 60%, the above four multiplying benefits (100%/40%)×(100%/40%)×(100%/40%)×2 divided by N are combined, and the lifetime of the start-up battery 33 is increased by more than 31 times divided by N; or by setting the electrical output ratio Rᵣ₁₀ of the start-up battery 33 to 30% and setting the electrical output ratio Rᵣ₂₀ of the higher voltage rapid energy storage module 13 to 70%, the above four multiplying benefits (100%/30%)×(100%/30%)×(100%/30%)×2 divided by N are combined, and the lifetime of the start-up battery 33 is increased by more than 74 times divided by N; or by setting the electrical output ratio Rᵣ₁₀ of the start-up battery 33 to 20% and setting the electrical output ratio Rᵣ₂₀ of the higher voltage rapid energy storage module 13 to 80%, the above four multiplying benefits (100%/20%)×(100%/20%)×(100%/20%)×2 divided by N are combined, and the lifetime of the start-up battery 33 is increased by more than 250 times divided by N. Thus, the range of the electrical output ratio of the start-up battery 33 is between 20% and 50%; or the range of the electrical output ratio of the start-up battery 33 is between 30% and 40% and the range of the electrical output ratio of the higher voltage rapid energy storage module 13 is between 50% and 80%; or the range of the electrical output ratio of the higher voltage rapid energy storage module 13 is between 60% and 70%. The sum of the electrical output ratio of the start-up battery 33 plus the higher voltage rapid energy storage module 13 is equal to 1. In this way, the deterioration degree of the start-up battery 33 (such as a lead-acid battery) can be greatly reduced, and the purpose of extending the service lifetime of the start-up battery 33 can be achieved.

When the voltage of the start-up battery 33 is too low, it is also referred to as undervoltage, which means that the start-up motor 31 cannot start normally. In a charging mode, the higher voltage rapid energy storage module 13 is disconnected from the parallel connection with the start-up battery 33, and the start-up battery 33 is boosted to charge the higher voltage rapid storage module 13. By boosting the voltage V_{C} of the higher voltage rapid energy storage module 13, the low-voltage start-up battery 33 may be boosted to charge the higher voltage rapid energy storage module 13 through a buck-boost module (not shown) until a predetermined condition is met. The predetermined condition is that the voltage range of the higher voltage rapid energy storage module 13 connected in parallel to the start-up battery 33 is between greater than the voltage of the start-up battery 33 and less than or equal to a rated voltage of the higher voltage rapid storage module 13, such that the higher voltage rapid energy storage module 13 can maintain a higher voltage at any time to assist the start-up battery 33 in driving the load of the start-up motor 31. The higher voltage rapid energy storage module 13 (such as a supercapacitor set) has a capability of charging and discharging faster than the start-up battery 33, therefore the higher voltage rapid energy storage module 13 can be quickly charged to accumulate until the voltage V_{C} of the higher voltage rapid energy storage module 13 is greater than the voltage V_{TH} of the start-up battery 33. By increasing the voltage V_{C} of the higher voltage rapid energy storage module 13, in the start-up mode, with the higher voltage rapid energy storage module 13 connected in parallel to the start-up battery 33, the loaded current I_{C} of the higher voltage rapid energy storage module 13 can be effectively increased, then the loaded current I_{TH} of the battery 33 can be reduced, so as to increase the electrical output ratio of the higher voltage rapid energy storage module 13 and reduce the electrical output ratio of the start-up battery 33. Therefore, the lifetime of the start-up battery 33 can be effectively extended.

Furthermore, the way of increasing the voltage V_{C} of the higher voltage rapid energy storage module 13 (such as a supercapacitor set) is related to the number of supercapacitors connected in series and the operating voltage. For example, the rated voltage of a lead-acid battery is generally 14V. If V_{C} is set to 16V, the rated voltage V_{1C} of one supercapacitor is 2.7V. By the following formula: NC=V_{C}/V_{1C}, it can be calculated that the number of supercapacitors NC is 6. In fact, the rated voltage that the supercapacitor set may operate is 2.7 V×6=16.2V. The supercapacitor set connected in parallel to the start-up battery 33 (for example, a lead-acid battery) may be charged by the start-up battery 33 (for example, a lead-acid battery) until a predetermined condition is met. The predetermined condition is that the range of the voltage of the supercapacitor set connected in parallel to the start-up battery 33 is between greater than the voltage of the start-up battery 33 and less than or equal to the rated voltage of the supercapacitor set, which is 2.7 V×6=16.2 V.

The system 10 for output ratio configuration of start-up battery and rapid energy storage module in parallel of the disclosure is not limited to vehicles. The system 10 for output ratio configuration of start-up battery and rapid energy storage module in parallel may also be applied to various possible devices that require larger amount of power to start the start-up motor 31, such as wireless vacuum cleaners, diesel generators, and the like, or devices that are powered by the start-up battery 33 but require a large load such as a larger current instantaneously. Therefore, the so-called start is only a representative word, which actually includes any conditions and systems that require a larger current.

Finally, it is emphasized that the constituent elements disclosed in the previously mentioned embodiments of the disclosure are only examples and are not used to limit the scope of the application. Alternatives or changes to other equivalent elements should also be covered by the scope of the patent application of this application.

It will be apparent to those skilled in the art that various modifications and variations may be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A system for output ratio configuration of start-up battery and rapid energy storage module in parallel, starting a start-up motor in a start-up mode and comprising:
a start-up battery having a voltage; and
a higher voltage rapid energy storage module having a voltage, the higher voltage rapid energy storage module connected in parallel to the start-up battery;
wherein in the start-up mode, the voltage of the higher voltage rapid energy storage module for connecting the start-up battery in parallel is greater than the voltage of the start-up battery, which is used to set an electrical output ratio of the start-up battery and the higher voltage rapid energy storage module respectively to provide for a load current of the start-up motor, wherein a sum of the electrical output ratio of the start-up battery plus the electrical output ratio of the higher voltage rapid energy storage module is equal to 1, so as to extend a lifetime of the start-up battery.

2. The system for output ratio configuration of start-up battery and rapid energy storage module in parallel as described in claim 1, wherein the following formulas are satisfied: Rᵣ₁₀=I_{TH}/(I_{TH}−I_{C}), and Rᵣ₂₀=I_{C}/(I_{TH}−I_{C}), wherein I_{TH}=(V_{TH}−R_{L}×(I_{TH}+I_{C}))/R_{TH}, and I_{C}=(V_{C}−R_{L}×(I_{TH}+I_{C}))/R_{C}, wherein V_{TH} is the voltage of the start-up battery; V_{C} is the voltage of the higher voltage rapid energy storage module; Rᵣ₁₀ is the electrical output ratio of the start-up battery connected in parallel to the higher voltage rapid energy storage module; Rᵣ₂₀ is the electrical output ratio of the higher voltage rapid energy storage module connected in parallel to the start-up battery; R_{TH} is an internal resistance value of the start-up battery; I_{TH} is a loaded current of the start-up battery; I_{C} is a loaded current of the higher voltage rapid energy storage module; R_{C} is an internal resistance value of the higher voltage rapid energy storage module; and R_{L} is a load impedance value of the start-up motor.

3. The system for output ratio configuration of start-up battery and rapid energy storage module in parallel as described in claim 1, wherein a range of the electrical output ratio of the start-up battery is between 20% and 80% and a range of the electrical output ratio of the higher voltage rapid energy storage module is between 20% and 80%.

4. The system for output ratio configuration of start-up battery and rapid energy storage module in parallel as described in claim 3, wherein the electrical output ratio Rᵣ₁₀ of the start-up battery is set to 80%, the electrical output ratio Rᵣ₂₀ of the higher voltage rapid energy storage module is set to 20%, and the start-up battery increases a lifetime by more than 3 times; or the electrical output ratio Rᵣ₁₀ of the start-up battery is set to 70%, the electrical output ratio Rᵣ₂₀ of the higher voltage rapid energy storage module is set to 30%, and the start-up battery can increase the lifetime by more than 5 times; or the electrical output ratio Rᵣ₁₀ of the start-up battery is set to 60%, the electrical output ratio Rᵣ₂₀ of the higher voltage rapid energy storage module is set to 40%, and the start-up battery can increase the lifetime by more than 9 times; or the electrical output ratio Rᵣ₁₀ of the start-up battery is set to 50%, the electrical output ratio Rᵣ₂₀ of the higher voltage rapid energy storage module is set to 50%, and the start-up battery can increase the lifetime by more than 16 times; or the electrical output ratio Rᵣ₁₀ of the start-up battery is set to 40%, the electrical output ratio Rᵣ₂₀ of the higher voltage rapid energy storage module is set to 60%, and the start-up battery can increase the lifetime by more than 31 times; or the electrical output ratio Rᵣ₁₀ of the start-up battery is set to 30%, the electrical output ratio Rᵣ₂₀ of the higher voltage rapid energy storage module is set to 70%, and the start-up battery can increase the lifetime by more than 74 times; or the electrical output ratio Rᵣ₁₀ of the start-up battery is set to 20%, the electrical output ratio Rᵣ₂₀ of the higher voltage rapid energy storage module is set to 80%, and the start-up battery can increase the lifetime by more than 250 times.

5. The system for output ratio configuration of start-up battery and rapid energy storage module in parallel as described in claim 4, wherein the start-up motor is configured to restart a vehicle engine having an idling stop system, in which a number of starts is N times compared with a conventional start-up motor wherein N is an arithmetical average or a rounded positive integer, wherein the range of the electrical output ratio of the start-up battery is between 20% and 50%, and the range of the electrical output ratio of the higher voltage rapid energy storage module is between 50% and 80%.

6. The system for output ratio configuration of start-up battery and rapid energy storage module in parallel as described in claim 5, wherein the electrical output ratio Rᵣ₁₀ of the start-up battery is set to 50%, the electrical output ratio Rᵣ₂₀ of the higher voltage rapid energy storage module is set to 50%, and the start-up battery increases a lifetime by 16 times divided by N or more; or the electrical output ratio Rᵣ₁₀ of the start-up battery is set to 40%, the electrical output ratio Rᵣ₂₀ of the higher voltage rapid energy storage module is set to 60%, and the start-up battery increases a lifetime by 31 times divided by N or more; or the electrical output ratio Rᵣ₁₀ of the start-up battery is set to 30%, the electrical output ratio Rᵣ₂₀ of the higher voltage rapid energy storage module is set to 70%, and the start-up battery increases a lifetime by 74 times divided by N or more; or the electrical output ratio Rᵣ₁₀ of the start-up battery is set to 20%, the electrical output ratio Rᵣ₂₀ of the higher voltage rapid energy storage module is set to 80%, and the start-up battery increases a lifetime by 250 times divided by N or more.

7. The system for output ratio configuration of start-up battery and rapid energy storage module in parallel as described in claim 1, wherein the start-up motor, after connecting to the start-up battery and started, immediately enters the start-up mode after a time point at which the voltage of the start-up battery drops instantaneously to produce a predetermined voltage difference, wherein the predetermined voltage difference is the voltage of the start-up battery when the start-up motor stops, minus the voltage of the start-up battery when a loaded current of the start-up battery flows through an internal resistance value of the start-up battery.

8. The system for output ratio configuration of start-up battery and rapid energy storage module in parallel as described in claim 1, further comprising a charging mode, wherein in the charging mode, the higher voltage rapid energy storage module is disconnected from the parallel connection with the start-up battery, and the start-up battery is boosted so as to charge the higher voltage rapid energy storage module until a predetermined condition is met, wherein the predetermined condition is that a range of the voltage of the higher voltage rapid energy storage module for connecting the start-up battery in parallel is between greater than the voltage of the start-up battery and less than or equal to a rated voltage of the higher voltage rapid energy storage module.
